(19) United States
(12) Patent Application Publication
(10) Pub. No.: US 2004/0262269 A1
(43) Pub. Date: Dec. 30, 2004

(54) Hybrid laser-arc welding method with gas flow rate adjustment

(76) Inventor: Olivier Matile, Paris (FR)

Correspondence Address: Air Liquide, Intellectual Property Department, Suite 1800, 2700 Post Oak Boulevard, Houston, TX, 77056, US

(21) Appl. No.: 10/489,445

(22) PCT Filed: Jul. 29, 2002
(86) PCT No.: PCT/FR02/02717

(30) Foreign Application Priority Data
Sep. 13, 2001 (FR) 01/11855

(51) Int. Cl. B23K 10/02; B23K 26/20

(52) U.S. Cl. 219/121.46; 219/121.64; 219/121.84

(57) ABSTRACT

A hybrid welding process combining a laser beam and an electric arc, in particular a plasma arc, using special gases or gas mixtures as electric arc striking gases and shielding gases, and to its application to the welding of pipes or tubes or to the welding of tailored blanks, especially those that can be used in the automobile industry.

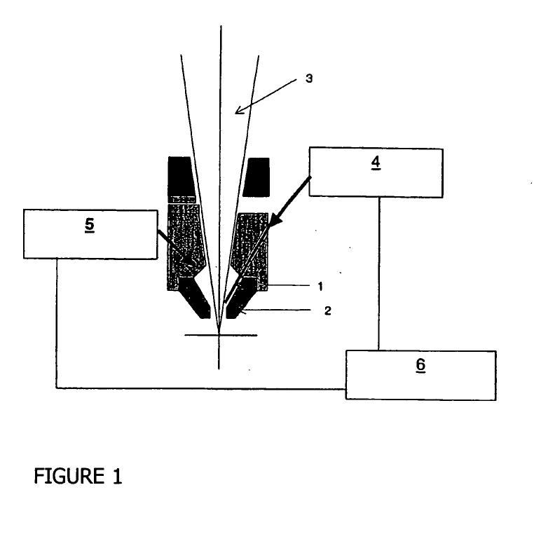

The present invention relates to a hybrid welding process and to a hybrid welding set combining a laser beam and an electric arc, in particular a plasma arc, using special gases or gas mixtures as electric arc striking gases and laser beam assistance gases, and to its application to the welding of pipes or tubes or to the welding of tailored blanks, especially those that can be used in the automobile industry.

In plasma arc welding, correct and effective striking of the arc, at the start of a welding operation, is of paramount importance and is indispensable since, if there is no striking at all, the welding cannot take place for lack of an electric arc, while if the arc is struck incorrectly this may result in damage to certain components of the welding head, for example the nozzle.

At the present time, there are various ways in which to strike an arc in an electric arc torch, namely:

striking by a pilot spark resulting from the use either of a high voltage, typically from 2000 to 5000 volts, or a high frequency, for example 10 to 50 kHz. However, this method has the drawback of causing electromagnetic interference—by radiative or conductive means—with a risk of damaging the electrical or electronic equipment;

striking by a pilot arc with a low-power electric arc created between the electrode and the nozzle of the torch. This technique has the advantage of causing no electromagnetic interference.

In both cases, when the arc is struck, it is then transferred onto the workpiece(s) to be welded.

However, whatever the technology employed, arc striking preferably takes place in a gas having a low ionization potential, which gas must also be inert so as not to cause any contamination or deterioration of the electrode and also not to react negatively with the molten metal.

As may be seen in the following table, argon meets these conditions as it is inert and has a relatively low ionization potential, unlike nitrogen or CO₂, which, although having even lower ionization potentials, may react with the molten metal, for example, forming nitrides in the case of nitrogen and damaging the tungsten electrode in the case of CO₂.

| | Ionization potential |
|---|---|
| Gas | (eV) |
| He | 24.46 |
| Ar | 15.68 |
| N₂ | 15.51 |
| CO₂ | 14.4 |

Furthermore, in plasma arc welding, it is customary to use plasma gases containing mainly argon.

In other words, in plasma arc welding, only argon or an argon-based gas is used to strike the arc, after which the actual welding operation is carried out.

Moreover, in laser beam welding, in particular with laser sources of the CO₂ gas type, owing to the high specific power levels involved, generally a few kilowatts, production of the weld relies on the phenomenon of localized melting of the material at the point of impact of the laser beam where a capillary, filled with metal vapors ionized at high temperature, forms, said vapor capillary being called a keyhole. The walls of this keyhole are formed from molten metal.

This keyhole plays an important role as it allows energy to be transferred directly to the core of the material.

The weld pool thus formed and maintained is progressively displaced between the workpieces to be joined together, depending on the relative displacement of the laser beam over the workpieces to be welded, and the metal of the welded joint solidifies after the laser beam has passed, ensuring contiguous joining of the workpieces.

The appearance of the keyhole is accompanied by the formation of a metal vapor plasma, that is to say an electrically neutral ionized gas medium at a temperature of several thousands of degrees.

The metal vapor plasma results from good coupling between the laser beam and the workpiece, and is therefore inevitable. This type of plasma absorbs a small amount of the incident energy and does not appreciably modify the width and the depth of the weld bead.

Under certain conditions, relating to power, speed, thickness nature and composition of the gas, configuration, etc., the metal vapor plasma transfers some of its energy to the shielding gas used to shield the welding zone from any contamination by atmospheric impurities, and there is then a risk of creating another plasma arising from the shielding gas.

In actual fact, the creation of such a plasma from the shielding gas may absorb energy from the incident laser beam and, in this case, the weld bead becomes broader at the surface and penetrates much less into the thickness of the workpieces to be welded.

To counteract the creation of the shielding gas plasma, it is necessary to use a gas having a high ionization potential and it turns out that helium is the most appropriate gas for limiting the occurrence of this type of plasma.

In recent years there has been developed, in parallel with the abovementioned welding processes, a welding process called laser/arc hybrid welding, based on the combination of a laser beam and an electric arc.

Laser/arc hybrid welding processes have been described, in particular in documents EP-A-793558; EP-A-782489; EP-A-800434; U.S. Pat. No. 5,006,688; U.S. Pat. No. 5,700,989; EP-A-844042; “Laser GTA Welding of aluminium alloy 5052” by T. P. Diebold and C. E. Albright, 1984, pages 18-24; SU-A-1815085 and U.S. Pat. No. 4,689,466; “Plasma arc augmented laser welding” by R. P. Walduck and J. Biffin, pages 172-176, 1994; and “TIG or MIG arc augmented laser welding of thick mild steel plate”, Joining and Materials, by J. Matsuda et al., pages 31-34, 1988.

In general a plasma/laser or, more generally, laser/arc hybrid welding process is a combined or mixed welding process that combines electric arc welding with a laser beam. The laser/arc process consists in generating an electric arc between an electrode, which may or may not be consumable, and the workpiece to be welded, and in focusing a powerful laser beam, especially a YAG-type or CO₂-type laser, in the arc zone, that is to say near or in the joint plane obtained by joining together, edge to edge, the parts that are to be welded together.

Such a hybrid process makes it possible to considerably improve welding speeds compared to laser welding alone or to arc or plasma welding alone and, in addition, it makes it possible to appreciably increase the tolerances on positioning the edges before welding and also the tolerated gap between the edges to be welded, in particular compared to laser beam welding alone, which requires high precision in positioning the parts to be welded because of the small size of the focal spot of the laser beam.

The use of a laser/arc hybrid welding process requires the use of a welding head that makes it possible to combine the laser beam, its focusing device and a suitable welding electrode.

Several head configurations are described in the abovementioned documents and it may be stated, in summary, that the laser beam and the electric arc or plasma jet may be delivered by one and the same welding head, that is to say they leave via the same orifice, or else via two separate welding heads, one delivering the laser beam and the other the electric arc or plasma jet, the beam and the arc/plasma being combined in the welding zone, as taught for example by documents WO-A-01/05550 and EP-A-1 084 789.

Hybrid laser/arc processes are reputed to be perfectly suitable for welding tailored blanks for the automobile industry, since they make it possible to obtain a weld bead that is well wetted and free of undercuts, as mentioned in documents EP-A-782 489 and “Laser plus arc equals power”, Industrial Laser Solutions, February 1999, pages 28-30.

During production of the welded joint, it is essential to use an assistance gas, in order to assist the laser beam and to shield the welding zone from external attack, and a gas for the electric arc, in particular a plasma gas serving to create the arc plasma jet in the case of a plasma arc process.

Thus, it will be readily understood that, when a laser source is coupled with a plasma arc welding device in order to implement a laser/plasma arc hybrid welding process, the above problem then becomes very complex as it is then necessary not only to avoid the formation of the shielding gas plasma near the weld pool, but also to be able to obtain correct striking of the arc generated by the electrode.

As explained above, the plasma gas must essentially contain argon in order to allow effective striking of the arc.

However, upon contact with the metal vapor plasma generated by impact of the laser beam on the material to be welded, an argon-rich plasma gas may easily ionize and create a plasma that absorbs the laser beam and is therefore deleterious to the quality of the weld, as it reduces the depth of penetration of the beam.

Conversely, the gas for shielding the weld pool must contain predominantly helium in order to prevent the formation of an absorbent plasma.

However, if the end of the electrode is surrounded by and in contact with helium in a high proportion, it will not be possible to correctly strike the plasma arc.

It is an object of the present invention therefore to propose a laser/arc hybrid welding process that does not pose these problems, that is to say a laser/arc, particularly laser/plasma arc, hybrid welding process with effective striking and no or almost no absorbent plasma being formed.

The solution of the invention is therefore a laser/arc hybrid welding process for welding one or more metal workpieces to be welded by producing at least one welded joint between the edges to be welded, carried by said metal workpiece or workpieces, said welded joint being obtained by using at least one laser beam and at least one electric arc, which combine with one another so as to cause melting followed by subsequent solidification of the metal along said edges to be welded, which process is carried out as follows:

(a) striking of at least one electric arc, using at least one electrode supplied with electric current, in the presence of a gaseous striking composition containing at least 50% argon by volume in order to strike a pilot arc;

(b) transfer of the pilot arc struck at step (a) to the workpieces to be welded; and

(c) injection, into the welding zone, of a gaseous shielding atmosphere containing at least 50% helium by volume, in order to shield at least part of the welding zone, and welding of the welded joint in the presence of said gaseous shielding atmosphere, by combining the laser beam with the electric arc.

Depending on the case, the process of the invention may include one or more of the following technical features:

at step (a), the gaseous striking composition contains more than 60% argon by volume, preferably 70 to 100% argon by volume;

at step (a), the striking gas also contains at least one additional, non-oxidizing, compound chosen from helium, H₂ and N₂ in a concentration of 0.05 to 30% by volume;

at step (a), the electric arc is struck between an electrode and a nozzle so as subsequently to obtain a plasma arc;

at step (b), the pilot arc is transferred by bringing the welding head delivering the plasma arc up to the workpiece to be welded;

at step (c), the gaseous shielding atmosphere contains at least 40% helium by volume, preferably 50 to 100% helium by volume;

at step (c), the gaseous shielding atmosphere contains, in addition, at least one additive compound chosen from argon, H₂, O₂, CO₂ and N₂ in a concentration of 0.05 to 30% by volume;

at step (c), the laser beam and the plasma arc are delivered, being combined together, via the same orifice of a welding nozzle;

the workpiece or workpieces to be welded are made of a metal or a metal alloy chosen from clad or unclad steels, particularly joining steels, high-yield-strength steels, carbon steels, steels having on the surface a zinc alloy coating, stainless steels, aluminum or aluminum alloys;

the workpiece or workpieces to be welded have a thickness between 0.1 and 70 mm, preferably between 0.3 and 50 mm;

the workpiece or workpieces to be welded are tailored blanks forming components of an automobile body;

it furthermore includes a step of detecting the formation or the existence of a pilot arc struck at step (a) between the electrode and the nozzle;

at step (a), the gaseous striking composition contains argon and helium, and in that, at step (c), the gaseous shielding atmosphere contains argon and helium and in that the gaseous striking composition and the gaseous shielding atmosphere contain unequal proportions of helium and/or argon;

the switch from the use of the gaseous striking composition to the use of the gaseous shielding atmosphere in order to supply the welding head is made during the transfer of step (b) or immediately after the transfer of the pilot arc to the workpieces to be welded, preferably after the transfer of the pilot arc;

the workpiece to be welded is welded so as to obtain a tube or pipe.

The invention also relates to a process for manufacturing automobile body components, in which workpieces forming automobile body components are welded together by implementing a hybrid welding process according to the invention.

The invention is illustrated in the appended figure, which shows part of a hybrid welding set according to the invention, which usually comprises a gas laser (CO₂ laser) oscillator that produces a high-energy coherent monochromatic beam 3, an optical path equipped with deflection mirrors for bringing the laser beam 3 into a welding head located opposite the tube or pipe to be welded.

The welding head conventionally comprises a lens or one or more focusing mirrors so as to focus the laser beam 3 at one or more focal spots in the thickness of the workpieces 10, 11 to be welded and in the joint plane 9 obtained by the joining, in a butt, lap or other configuration, of the edges of the workpieces to be assembled.

Furthermore, an arc plasma jet is obtained by means of an electrode 1 and a plasma gas 4.

The laser beam 3 and the plasma jet combine in the welding head so as to be expelled together via the single orifice of the nozzle 2 in order to cause local power density concentration sufficient to melt the edges of the workpieces to be welded.

It has been demonstrated by the inventors of the present invention that, in order to obtain effective striking, it is necessary to introduce, in contact with the electrode 1, pure argon or a gas mixture containing essentially argon, typically 70 to 100% argon by volume, and the rest possibly being helium, hydrogen or any other appropriate non-oxidizing gas or gas mixture.

As may be seen in the appended figure, this gaseous striking composition, coming from the source 4, is introduced into the welding head in the immediate vicinity of and/or around the electrode 1 so as to strike a pilot arc between said non-consumable electrode 1 and the nozzle 2.

Next, when this pilot arc has been correctly struck, it is transferred to the workpieces to be welded together, being expelled via the single orifice of the nozzle 2 of the welding head.

The shielding gas, coming from a shielding gas source 5, is then introduced in order to shield the weld pool, that is to say the welded joint being formed.

This shielding gas is formed according to the invention from helium or a gas mixture based on helium, which preferably contains 50 to 100% helium by volume, the rest possibly being argon, hydrogen or any other appropriate gas or gas mixture.

By proceeding in this manner, the conditions are such that deleterious plasma coming from the shielding gas does not form on contact with the metal vapor plasma and therefore a large proportion of the laser beam 3 is not absorbed.

The gas streams are managed by means of a conventional control unit 6 in such a way that, until correct striking has occurred, it supplies the welding head with plasma gas (4), whereas once the pilot electric arc has been detected by the control unit 6 the latter opens a solenoid valve (not shown) so as to deliver the shielding gas (5) in order to increase, for example, the helium content in the head so as to change from a gaseous atmosphere containing predominantly argon, used to strike the pilot arc, to a gaseous atmosphere containing predominantly helium that can be used for welding.

A striking cycle is, for example, the following:

opening of the valve allowing influx of the plasma gas 4 around the electrode, for example argon with a flow rate of about 5 l/min;

next, supply of a current of low amperage between the electrode and the nozzle in order to strike the pilot arc;

when the pilot arc has been detected, the welding head is brought up to the workpieces to be welded so as to create a plasma with injection of a shielding gas, for example helium, with a flow rate of 20 l/min so as to shield the weld pool formed; and

next, the laser beam 3 is emitted and the intensity then takes its welding setpoint value, the beam combining with the arc plasma.

The action of bringing the welding head up to the workpiece or workpieces to be welded, so as to create the plasma arc, is therefore advantageously carried out after a pilot arc has been detected, preferably said action is carried out almost simultaneously with the injection of the gaseous shielding atmosphere containing at least 50% helium by volume.

Furthermore, as regards the laser beam, this is emitted, that is to say guided or sent into the zone to be melted, simultaneously with or after the formation of the plasma arc so that said beam combines with the plasma arc after said plasma arc has been formed.

The invention is particularly applicable to the welding of tubes or pipes, by axial or helical welding, or of tailored blanks intended to constitute at least part of a vehicle body component.

The invention therefore also relates to a process for manufacturing a longitudinally or spirally welded tube or pipe, in which the edges of the tube or pipe are welded together by implementing a hybrid welding process according to the invention.

The invention may be used for joining together, by hybrid welding, metal workpieces having the same or different thicknesses and/or the same or different metallurgical compositions or metallurgical grades and/or the same or different thicknesses.

In addition, depending on the welding methods and preparations used, the joint to be welded is often characterized by a difference in level between the upper planes of each of the workpieces to be welded, thus resulting in the creation of a “step”; however, the reverse situation may also be encountered, namely joints of the tailored-blank type in which the upper planes are aligned but the lower planes of which are not on the same level and in which the “step” is located on the reverse side of the joint to be welded.

Welds of this kind are frequently found in the automobile industry in which the workpieces, once they have been welded, are drawn in order to give them their final shapes, for example the various components involved in the manufacture of a car body, and especially the doors, the roof, the hood and the trunk, or structural components of the interior.

Of course, in all cases the workpiece or workpieces to be welded and the welding head are made to undergo a movement of relative displacement one with respect to the other, that is to say either the workpiece or workpieces are stationary and the welding head moves, or vice versa.

Moreover, it goes without saying that the welding phase may be carried out in one or more passes, depending in particular on the diameter and the thickness to be welded.

1-19. (canceled).

20. A laser/arc hybrid welding process comprising:
a) introducing one or more metal workpieces to be welded, said one or more workpieces comprising a first edge and a second edge;
b) introducing a hybrid welding head, said hybrid welding head comprising a nozzle, at least one laser beam, and at least one electric arc, said at least one electric arc comprising an electrode;
c) introducing a striking gas to said hybrid welding head, said striking gas comprising at least about 50% argon by volume;
d) supplying said electrode with an electrical current and bringing said electrode into contact with said striking gas, thereby striking at least one pilot arc between said electrode and said nozzle;
e) transferring said pilot arc to said first edge and said second edge, thereby forming a welding zone;
f) combining said at least one laser beam with said at least one electric arc to form a laser/arc hybrid welding process within said welding zone, thereby causing said metal workpieces to melt, said melting followed by a subsequent solidification along said first edge and said second edge, resulting in a hybrid laser/arc hybrid weld being formed;
g) introducing a gaseous shielding atmosphere to said hybrid welding head, said gaseous shielding atmosphere comprising at least about 50% helium by volume; and
h) shielding at least part of said welding zone with said gaseous shielding atmosphere during said laser/arc hybrid welding process.

21. The laser/arc hybrid welding process of claim 20, wherein said striking gas comprises more than about 60% argon by volume.

22. The laser/arc hybrid welding process of claim 21, wherein said striking gas comprises between about 70% to about 100% argon by volume.

23. The laser/arc hybrid welding process of claim 20, wherein said striking gas comprises at least one additional, non-oxidizing compound selected from the group consisting of helium, H2, and N2, wherein said additional, non-oxidizing compound comprises between about 0.05% and about 30% by volume of said striking gas.

24. The laser/arc hybrid welding process of claim 20, wherein said pilot arc is struck between said electrode and said nozzle so as to subsequently obtain a plasma arc.

25. The laser/arc hybrid welding process of claim 24, wherein said plasma arc is transferred by bringing said hybrid welding head up to said at least one workpiece.

26. The laser/arc hybrid welding process of claim 20, wherein said gaseous shielding atmosphere comprises at least about 40% helium by volume.

27. The laser/arc hybrid welding process of claim 26, wherein said gaseous shielding atmosphere comprises between about 50% to about 100% helium by volume.

28. The laser/arc hybrid welding process of claim 20, wherein said gaseous shielding atmosphere comprises at least one additional additive compound selected from the group consisting of argon, H2, O2, CO2, and N2, wherein said additional additive compound comprises between about 0.05% and about 30% by volume of said gaseous shielding atmosphere.

29. The laser/arc hybrid welding process of claim 24, wherein said laser beam and said plasma arc are combined, and delivered via the same orifice in said welding nozzle.

30. The laser/arc hybrid welding process of claim 20, wherein said one or more workpieces are comprised of a metal or metal alloy chosen from the group consisting of clad steels, unclad steels, carbon steels, steels having on the surface a zinc alloy coating, stainless steels, aluminum, and aluminum alloys.

31. The laser/arc hybrid welding process of claim 20, wherein said one or more workpieces have a thickness of between about 0.1 and about 70 mm.

32. The laser/arc hybrid welding process of claim 31, wherein said one or more workpieces have a thickness of between about 0.3 and about 50 mm.

33. The laser/arc hybrid welding process of claim 20, wherein said one or more workpieces are tailored blanks forming components of an automobile body.

34. The laser/arc hybrid welding process of claim 20, wherein step d) further comprises detecting said pilot arc.

35. The laser/arc hybrid welding process of claim 25, wherein step d) further comprises detecting said pilot arc.

36. The laser/arc hybrid welding process of claim 20, wherein said striking gas comprises argon and helium in a first blend ratio, said gaseous shielding atmosphere comprises argon and helium in a second blend ratio, and said first blend ratio is not equal to said second blend ratio.

37. The laser/arc hybrid welding process of claim 20, wherein said introduction of said gaseous shielding atmosphere as said pilot arc is transferred to said first edge and said second edge.

38. The laser/arc hybrid welding process of claim 20, wherein said introduction of said gaseous shielding atmosphere after said pilot arc is transferred to said first edge and said second edge.

39. The laser/arc hybrid welding process of claim 20, wherein said one or more workpieces are welded as to obtain a tube or pipe.

40. The laser/arc hybrid welding process of claim 34, wherein said action of bringing said hybrid welding head up to said one or more workpieces is carried out after said detection of said pilot arc.

41. The laser/arc hybrid welding process of claim 40, wherein said action of bringing said hybrid welding head up to said one or more workpieces is carried out after said detection of said pilot arc, and simultaneous with the introduction of said gaseous shielding atmosphere, said gaseous shielding atmosphere comprising at least about 50% helium by volume.

42. The laser/arc hybrid welding process of claim 24, wherein said laser beam is emitted simultaneous with said formation of said plasma arc, thereby combining said laser beam with said plasma arc.

43. The laser/arc hybrid welding process of claim 24, wherein said laser beam is emitted subsequent to said formation of said plasma arc, thereby combining said laser beam with said plasma arc.

44. A process for manufacturing automobile body components, wherein said components are comprised of workpieces welded in accordance with a process comprising:
a) introducing one or more metal workpieces to be welded, said one or more workpieces comprising a first edge and a second edge;
b) introducing a hybrid welding head, said hybrid welding head comprising a nozzle, at least one laser beam, and at least one electric arc, said at least one electric arc comprising an electrode;
c) introducing a striking gas to said hybrid welding head, said striking gas comprising at least about 50% argon by volume;
d) supplying said electrode with an electrical current and bringing said electrode into contact with said striking gas, thereby striking at least one pilot arc between said electrode and said nozzle;
e) transferring said pilot arc to said first edge and said second edge, thereby forming a welding zone;
f) combining said at least one laser beam with said at least one electric arc to form a laser/arc hybrid welding process within said welding zone, thereby causing said metal workpieces to melt, said melting followed by a subsequent solidification along said first edge and said second edge, resulting in a hybrid laser/arc hybrid weld being formed;
g) introducing a gaseous shielding atmosphere to said hybrid welding head, said gaseous shielding atmosphere comprising at least about 50% helium by volume; and
h) shielding at least part of said welding zone with said gaseous shielding atmosphere during said laser/arc hybrid welding process.

45. A process for manufacturing a longitudinally or spirally welded tube or pipe, wherein the edges of said tube or pipe are welded in accordance with a process comprising:
a) introducing one or more metal workpieces to be welded, said one or more workpieces comprising a first edge and a second edge;
b) introducing a hybrid welding head, said hybrid welding head comprising a nozzle, at least one laser beam, and at least one electric arc, said at least one electric arc comprising an electrode;
c) introducing a striking gas to said hybrid welding head, said striking gas comprising at least about 50% argon by volume;
d) supplying said electrode with an electrical current and bringing said electrode into contact with said striking gas, thereby striking at least one pilot arc between said electrode and said nozzle;
e) transferring said pilot arc to said first edge and said second edge, thereby forming a welding zone;
f) combining said at least one laser beam with said at least one electric arc to form a laser/arc hybrid welding process within said welding zone, thereby causing said metal workpieces to melt, said melting followed by a subsequent solidification along said first edge and said second edge, resulting in a hybrid laser/arc hybrid weld being formed;
g) introducing a gaseous shielding atmosphere to said hybrid welding head, said gaseous shielding atmosphere comprising at least about 50% helium by volume; and
h) shielding at least part of said welding zone with said gaseous shielding atmosphere during said laser/arc hybrid welding process.
